(19) United States
(12) Patent Application Publication
(10) Pub. No.: US 2020/0288201 A1
(43) Pub. Date: Sep. 10, 2020

(54) FRAUD PREVENTION METHOD, OPERATION DETECTION METHOD AND APPARATUS, AND ELECTRONIC DEVICE

(71) Applicant: HONG KONG LIVEME CORPORATION LIMITED, Hong Kong (CN)

(72) Inventors: Xiliang BAI, Cayman Islands (GB); Yang MO, Cayman Islands (GB)

(21) Appl. No.: 16/645,630

(22) PCT Filed: Aug. 2, 2018
(86) PCT No.: PCT/CN2018/098284

§ 371 Date: Mar. 9, 2020

(30) Foreign Application Priority Data
Sep. 13, 2017 (CN) 201710822356.7

(51) Int. Cl. H04N 21/4627; G06Q 30/02; G06Q 30/00; G06Q 50/26; G06N 5/02; H04N 21/442; H04N 21/2187; H04N 21/45

(52) U.S. Cl. CPC H04N 21/4627; G06Q 30/0236; G06Q 30/0185; H04N 21/4532; G06N 5/025; H04N 21/44204; H04N 21/2187; G06Q 50/265

(57) ABSTRACT

Embodiments of the present application provide a theft prevention method and apparatus, a method and apparatus for detecting operations, and an electronic device. The theft prevention method comprises: monitoring each operation of an account logged into a live broadcasting platform; for each operation of the account, detecting whether the operation is a preset operation that can obtain an asset reward from the live broadcasting platform; if the operation is the preset operation, determining whether the operation meets a preset normal operation rule; and if the operation does not meet the preset normal operation rule, freezing an asset of the account. With the embodiments of the present application, theft of live broadcasting platform assets can be effectively prevented, and losses of platform can be avoided.

The present application claims the priority to Chinese patent application No. 201710822356.7 filed with the China National Intellectual Property Administration on Sep. 13, 2017 and entitled “Fraud prevention method, operation detection method, and apparatus, and electronic device”, which is incorporated herein by reference in its entirety.

### TECHNICAL FIELD

The present application relates to the field of network live broadcasting technology, and in particular, to a theft prevention method and apparatus, a method and apparatus for detecting operations, and an electronic device.

### BACKGROUND

At present, with the development of live broadcasting technology, many network users can make or watch lives.

In order to encourage network users to use some functions provided by a live broadcasting platform (such as a function of sharing a live), the live broadcasting platform often rewards live broadcasting platform accounts using these functions with some assets, such as virtual gifts or platform currency.

However, some misbehaving network users may use this reward mechanism with malicious intention. After registering with a live broadcasting platform to obtain an account, they crack interfaces associated with these functions of the live platform, and act as a client to call these interfaces, so that the registered account can obtain asset rewards from the live broadcasting platform. This operation of obtaining assets without being authorized is referred to as theft. These misbehaving users may sell the stolen assets or somehow withdraw deposit from the assets. Live broadcasting platforms may suffer loss from this.

Therefore, how to provide a theft prevention solution to protect live broadcasting platform from such kind of loss becomes an urgent technical problem.

### SUMMARY

The purpose of the embodiments of the present application is to provide a theft prevention method and apparatus, a method and apparatus for detecting operations, and an electronic device. Abnormal operations can be detected, thereby protecting a live broadcasting platform from theft of asset, such that loss of the live broadcasting platform is avoided.

In a first aspect, embodiments of the present disclosure provide a theft prevention method including:

monitoring each operation of an account logged into a live broadcasting platform;

for each operation of the account, detecting whether the operation is a preset operation that can obtain an asset reward from the live broadcasting platform;

if the operation is the preset operation, determining whether the operation meets a preset normal operation rule; and

if the operation does not meet the preset normal operation rule, freezing an asset of the account.

Optionally, in an embodiment of the present application, determining whether the operation meets a preset normal operation rule comprises:

determining whether there is a preset normal operation of the account previous to the operation;

if there is a preset normal operation, determining that the operation meets the preset normal operation rule;

if there is no preset normal operation, determining that the operation does not meet the preset normal operation rule.

Optionally, if determining that there is a preset normal operation of the account, before determining that the operation meets the preset normal operation rule, the method further comprises:

determining whether the order in which operations of the account are executed meets a preset execution order;

if the preset execution order is met, triggering the step of determining that the operation meets the preset normal operation rule;

if the preset execution order is met, triggering the step of determining that the operation does not meet the preset normal operation rule.

Optionally, in another embodiment of the present application, determining whether the operation meets a preset normal operation rule comprises:

determining whether the number of executions of the operation within a first preset period is less than or equal to a preset execution number, wherein the preset execution number is determined based on the number of executions of the operation within the first preset period for a normal operation sample;

if the number of executions is less than or equal to the preset execution number, determining that the operation meets the preset normal operation rule;

if the number of executions is greater than the preset execution number, determining that the operation does not meet the preset normal operation rule.

Optionally, in the embodiment of the present application, the method may further include:

detecting whether the number of accounts registered with the live broadcasting platform within a second preset period exceeds a first threshold;

if the number of accounts exceeds the first threshold, determining whether the accounts registered with the live broadcasting platform within the second preset period meet a preset abnormal registration rule;

if the preset abnormal registration rule is met, freezing assets of the accounts registered with the live broadcasting platform within the second preset period.

Optionally, in an embodiment of the present application, the preset abnormal registration rule may comprise:

the number of accounts corresponding to the same registered IP address exceeds a first preset number;

and/or, the number of accounts corresponding to the same registered device exceeds a second preset number;

and/or, similarity between mailbox prefixes for accounts whose number exceeds a third preset number is greater than a second threshold.

In a second aspect, embodiments of the present disclosure provide a method for detecting operations, including:

monitoring each operation of an account logged in to a live broadcasting platform;

for each operation of the account, detecting whether the operation is a preset operation that can obtain an asset reward from the live broadcasting platform;

if the operation is the preset operation, determining whether the operation meets a preset normal operation rule;

determining that the operation is normal if the preset normal operation rule is met; and

determining that the operation is abnormal if the preset normal operation rule is not met.

Optionally, in an embodiment of the present application, determining whether the operation meets a preset normal operation rule comprises:

determining whether there is a preset normal operation of the account previous to the operation;

if there is a preset normal operation, determining that the operation meets the preset normal operation rule;

if there is no preset normal operation, determining that the operation does not meet the preset normal operation rule.

Optionally, if determining that there is a preset normal operation of the account, before determining that the operation meets the preset normal operation rule, the method further comprises:

determining whether the order in which operations of the account are executed meets a preset execution order;

if the preset execution order is met, triggering the step of determining that the operation meets the preset normal operation rule;

if the preset execution order is met, triggering the step of determining that the operation does not meet the preset normal operation rule.

Optionally, in a further embodiment of the present application, determining whether the operation meets a preset normal operation rule comprises:

determining whether the number of executions of the operation within a first preset period is less than or equal to a preset execution number, wherein the preset execution number is determined based on the number of executions of the operation within the first preset period for a normal operation sample;

if the number of executions is less than or equal to the preset execution number, determining that the operation meets the preset normal operation rule;

if the number of executions is greater than the preset execution number, determining that the operation does not meet the preset normal operation rule.

In the third aspect, an embodiment of the present application provides a theft prevention apparatus. The apparatus comprises:

a first monitoring module configured for monitoring each operation of an account logged in to a live broadcasting platform;

a first detecting module configured for detecting, for each operation of the account, whether the operation is a preset operation that can obtain an asset reward from the live broadcasting platform;

a first decision module configured for, determining whether the operation meets a preset normal operation rule if the first detecting module detects that the operation is a preset operation that can obtain an asset reward from the live broadcasting platform; and

a first freezing module configured for, freezing an asset of the account if the first decision module determines that the operation does not meet the preset normal operation rule.

Optionally, in an embodiment of the present application, the first decision module comprises:

a first decision sub-module configured for, determining whether there is a preset normal operation of the account previous to the operation if the first detecting module detects that the operation is a preset operation that can obtain an asset reward from the live broadcasting platform;

a first determining sub-module configured for, determining that the operation meets the preset normal operation rule if the first decision sub-module determines that there is a preset normal operation of the account previous to the operation; and

a second determining sub-module configured for, determining that the operation does not meet the preset normal operation rule if the first decision sub-module determines that there is no preset normal operation of the account previous to the operation.

Optionally, in an embodiment of the present application, the apparatus may further include:

a second decision sub-module, configured for:

determining whether the order in which operations of the account are executed meets a preset execution order if the first decision sub-module determines that there is a preset normal operation of the account previous to the operation;

if the preset execution order is met, triggering the first determining sub-module to determine that the operation meets the preset normal operation rule;

if the preset execution order is not met, triggering the second determining sub-module to determine that the operation does not meet the preset normal operation rule.

Optionally, in a further embodiment of the present application, the first decision module comprises:

a third decision sub-module configured for, determining whether the number of executions of the operation within a first preset period is less than or equal to a preset execution number if the first detecting module detects that the operation is the preset operation that can obtain an asset reward from the live broadcasting platform, wherein the preset execution number is determined based on the number of executions of the operation within the first preset period for a normal operation sample;

a third determining sub-module configured for, determining that the operation meets the preset normal operation rule if the third decision sub-module determines that the number of executions of the operation within the first preset period is less than or equal to the preset execution number; and

a fourth determining sub-module configured for, determining that the operation does not meet the preset normal operation rule if the third decision sub-module determines that the number of executions of the operation within the first preset period is greater than the preset execution number.

Optionally, in an embodiment of the present application, the apparatus may further include:

a second monitoring module configured for detecting whether the number of accounts registered with the live broadcasting platform within a second preset period exceeds a first threshold;

a second decision module configured for, determining whether the accounts registered with the live broadcasting platform within the second preset period meet a preset abnormal registration rule if the second monitoring module detects that the number of accounts registered with the live broadcasting platform within the second preset period exceeds the first threshold; and

a second freezing module configured for, freezing assets of the accounts registered with the live broadcasting platform within the second preset period if the second decision module determines that the accounts registered with the live broadcasting platform within the second preset period meet the preset abnormal registration rule.

Optionally, in the embodiment of the present application, the preset abnormal registration rule may include:

the number of accounts corresponding to the same registered IP address exceeds a first preset number;

and/or, the number of accounts corresponding to the same registered device exceeds a second preset number;

and/or, similarity between mailbox prefixes for accounts whose number exceeds a third preset number is greater than a second threshold.

In a fourth aspect, an embodiment of the present application provides an apparatus for detecting operations. The apparatus may include:

a third monitoring module configured for monitoring each operation of an account logged in to a live broadcasting platform;

a second detecting module configured for detecting, for each operation of the account, whether the operation is a preset operation that can obtain an asset reward from the live broadcasting platform;

a third decision module configured for, determining whether the operation meets a preset normal operation rule if the second detecting module detects that the operation is the preset operation that can obtain an asset reward from the live broadcasting platform;

a first determining module configured for, determining that the operation is normal if the third decision module determines that the operation meets the preset normal operation rule; and

a second determining module configured for, determining that the operation is abnormal if the third decision module determines that the operation does not meet the preset normal operation rule.

Optionally, in an embodiment of the present application, the third decision module may include:

a fourth decision sub-module configured for, determining whether there is a preset normal operation of the account previous to the operation if the second detecting module detects that the operation is a preset operation that can obtain an asset reward from the live broadcasting platform;

a fifth determining sub-module configured for, determining that the operation meets the preset normal operation rule if the fourth decision sub-module determines that there is a preset normal operation of the account previous to the operation; and

a sixth determining sub-module configured for, determining that the operation does not meet the preset normal operation rule if the fourth decision sub-module determines that there is no preset normal operation of the account previous to the operation.

Optionally, in an embodiment of the present application, the apparatus may further include:

a fifth decision sub-module configured for:

determining whether the order in which operations of the account are executed meets a preset execution order if the fourth decision sub-module determines that there is a preset normal operation of the account previous to the operation;

if the preset execution order is met, triggering the fifth determining sub-module to determine that the operation meets the preset normal operation rule;

if the preset execution order is not met, triggering the sixth determining sub-module to determine that the operation does not meet the preset normal operation rule.

Optionally, in a further embodiment of the present application, the third decision module may include:

a sixth decision sub-module, configured for, determining whether the number of executions of the operation within a first preset period is less than or equal to a preset execution number if the second detecting module detects that the operation is the preset operation that can obtain an asset reward from the live broadcasting platform, wherein the preset execution number is determined based on the number of executions of the operation within the first preset period for a normal operation sample;

a seventh determining sub-module configured for, determining that the operation meets the preset normal operation rule if the sixth decision sub-module determines that the number of executions of the operation within the first preset period is less than or equal to the preset execution number; and

an eighth determining sub-module configured for, determining that the operation does not meet the preset normal operation rule if the sixth decision sub-module determines that the number of executions of the operation within the first preset period is greater than the preset execution number.

In a fifth aspect, embodiments of the present application provide an electronic device, which may include a processor, a communication interface, a memory, and a communication bus, wherein the processor, the communication interface, and the memory communicate with each other through the communication bus;

the memory is configured for storing computer program codes;

The processor is configured for reading the executable program codes stored in the memory to execute the method steps of the theft prevention method according to any one of the first aspects.

In a sixth aspect, embodiments of the disclosure provide an electronic device may comprising a processor, a communications interface, a memory and a communication bus, wherein the processor, the communications interface, and the memory communicate with each other via the communication bus;

the memory is used for storing computer program codes;

the processor is configured to read the executable program codes stored in the memory to execute the method steps of the method for detecting operations according to any one of the second aspects.

In a seventh aspect, embodiments of the disclosure provide a computer readable storage medium having a computer program stored thereon which, when executed by a processor, causes the processor to perform the method steps of any of the first aspect.

In an eighth aspect, embodiments of the disclosure provide a computer readable storage medium having a computer program stored thereon which, when executed by a processor, causes the processor to perform the method steps of any of the second aspects.

In a ninth aspect, an embodiment of the present application further provides a computer program product containing instructions which, when executed on a computer, causes the computer to execute the method steps of the theft prevention method according to any one of the first aspect.

In a tenth aspect, an embodiment of the present application further provides a computer program product containing instructions which, when executed on a computer, causes the computer to execute the method steps of the method for detecting operations according to any one of the second aspects.

In the embodiment of the present application, the operations of each account logged in to a live broadcasting platform can be monitored, and each operation of each account being monitored can be detected to determine whether the operation is the preset operation that can obtain an asset reward from the live broadcasting platform. If the operation is a preset operation that can obtain an asset reward from the live broadcasting platform, a determination is made as to whether the operation meets a preset normal operation rule. A failure to meet the preset normal operation rule indicates that the operation is abnormal. In this case, the asset of the account corresponding to the operation is frozen to ensure that the assets of the live broadcasting platform are not stolen and the loss of the live broadcasting platform is avoided.

### BRIEF DESCRIPTION OF THE DRAWINGS

In order to more clearly describe the technical solution of the embodiments of the application or of the prior art, drawings needed in the embodiments and the prior art will be briefly described below. Obviously, the drawings described below are for only some embodiments of the present application, one of ordinary skills in the art can also obtain other drawings based on these drawings without any creative efforts.

FIG. 1 is a flowchart of a theft prevention method according to an embodiment of the present application;

FIG. 2 is a flowchart of another theft prevention method according to an embodiment of the present application;

FIG. 3 is a flowchart of a method for detecting operations according to an embodiment of the present application;

FIG. 4 is a schematic diagram depicting the structure of a theft prevention apparatus provided by an embodiment of the present application;

FIG. 5 is a schematic diagram depicting the structure of an apparatus for detecting operations provided by an embodiment of the present application;

FIG. 6 is a schematic diagram of the structure of an electronic device provided by an embodiment of the present application;

FIG. 7 is a schematic diagram of the structure of another electronic device provided by an embodiment of the present application.

### DETAILED DESCRIPTION

The technical solutions of the embodiments of the present application will be described clearly and completely in combination of the accompanying drawings of the embodiments of the present application. It is apparent that the described embodiments are only a part of the embodiments of the present application, and not all of them. All other embodiments obtained by a person of ordinary skill in the art based on the embodiments of the present application without any creative effort fall within the protection scope of the present application.

In order to solve the problem of theft of assets of live broadcasting platforms, the embodiments of the present application provide a theft prevention method, apparatus, and electronic device.

A theft prevention method according to an embodiment of the present application will be described below.

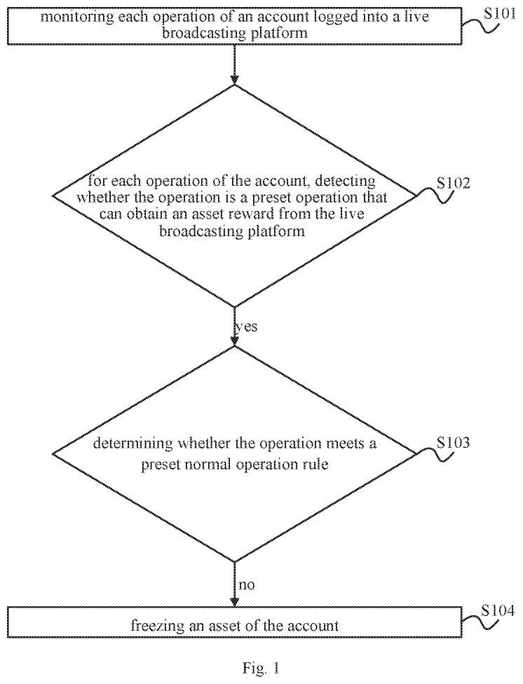

It should be noted that theft prevention method provided in the embodiments of the present application may be executed on a server for a live broadcasting platform. With reference to FIG. 1, the theft prevention method provided by an embodiment of the present invention may include the following steps:

S101: monitoring each operation of an account logged into a live broadcasting platform;

It is appreciated that operations of a logged-in account of the live broadcasting platform can be monitored by a server for the live broadcasting platform. The operations may include entering a live broadcasting studio, sharing a live, giving a gift, and exiting a broadcasting studio.

For example, the operations of a monitored account A logged in to a live broadcasting platform may include operations in the following sequence: opening an APP of the live broadcasting platform->logging into the live broadcasting platform->signing in->entering a live broadcasting studio->giving a gift->share a live->exit the studio->logging out the live broadcasting platform.

It should be noted that an account is associated with a user. Each operation of the account represents a user operation. A user operation refers to an operation performed through the account during the logging in to the live broadcasting platform or the process of using the live broadcasting platform after logging in to the live broadcasting platform.

S102: for each operation of the account, detecting whether the operation is a preset operation that can obtain an asset reward from the live broadcasting platform; if so, proceeding to step S103;

S103: determining whether the operation meets a preset normal operation rule; if the preset normal operation rule is not met, the method proceeds to step S104; if the preset normal operation rule is met, step S104 is skipped;

S104: freezing the asset of the account.

Continuing the above example and assuming that account A's operation of sharing a live is monitored by the server. At this time, a determination is made as to if the operation of sharing a live is a preset operation that can obtain an asset reward from the live broadcasting platform. The operation of sharing a live may not be further processed once determined not to be a preset operation that can obtain an asset reward from the live broadcasting platform. However, if the operation of sharing a live is a preset operation that can obtain an asset reward from the live broadcasting platform, a determination is made as to whether the sharing operation meets a preset normal operation rule. The result of meeting the preset normal operation rule indicates that the operation of sharing a live is a normal operation. In this case, the asset of account A is not to be frozen. In other words, the freezing of the assets of account A is skipped. A failure to meet the preset normal operation rule indicates that the operation of sharing a live is an abnormal operation. In this case, the asset of the account A can be frozen, such that the live broadcasting platform can be protected from theft of assets.

It is noted that the server may store an asset reward list that stores preset operations capable of obtaining an asset reward from a live broadcasting platform. For example, if a user is awarded with asset when he clicks to share a live, the operation of sharing a live is a preset operation that can obtain an asset reward from the live broadcasting platform.

It can be understood that the preset operations stored in the asset reward list can be adjusted according to actual needs. Details are not provided here. Moreover, in one implementation, an operation to be detected may be matched with preset operations stored in the asset reward list. A match with any of the preset operations in the asset reward list indicates that the operation can get an asset reward from the live broadcasting platform. A failure to match any of the preset operations in the asset reward indicates that the operation is not an operation that can obtain an asset reward from the live broadcasting platform.

Of course, preset operations that can obtain an asset reward from the live broadcasting platform can be provided with a flag for asset award. In this way, a to-be-detected operation having an asset award flag can be determined by a server as a preset operation that can obtain an asset reward from the live broadcasting platform. To the contrary, an operation without such a flag is determined not to be a preset operation that can obtain an asset reward from the live broadcasting platform.

In addition, it should be noted that the preset normal operation rule are derived from normal operation samples. Preset operations that can obtain an asset reward from the live broadcasting platform typically include operations such as signing in, sharing a live, and forwarding a live. These are operations that are performed after logging in to the live broadcasting platform. Therefore, it can be known that, under normal circumstances, there is at least an operation of logging in to the live broadcasting platform previous to a preset operation that can obtain an asset reward. Therefore, in one implementation, the preset normal operation rule may be set as: for an account corresponding to an operation at issue, there is a preset normal operation of the account previous to the operation.

Further, from normal operation samples, it can be known that various operations are performed in a specific order, for example, an account has to log in to the live broadcasting platform before sharing a live. Therefore, in another implementation, in order to improve the accuracy of the determination, the preset normal operation rule may be set as: for an account corresponding to an operation at issue, there is a preset normal operation of the account previous to the operation, and the order in which operations of the account are executed meets a preset execution order.

In addition, in the prior art, asset theft is typically committed by invoking a functional interface. This requires frequent interface invoking in a short period. Normal users, however, would not frequently perform an operation so frequently in a short period. For example, a normal user would not share a live for 1000 times in 1 minute. Therefore, in another implementation, the preset normal operation rule may be set as follows: the number of executions of an operation to be determined within a first preset time period is less than or equal to a preset execution number.

For the sake of clarity, the determination of whether an operation meets the preset normal operation rule is described in detail later.

In addition, the asset of an account may be frozen by prohibiting the asset interface of the account from being called. After the asset of the account is frozen, the server can send a prompt to the user terminal corresponding to the account that the asset has been disabled upon receiving an instruction for invoking the asset interface of the account. Of course, embodiments are not limited in this aspect.

It is noted that, in the prior art, in order to protect a live broadcasting platform from theft of assets, the live broadcasting platform may requires a user to bind his live broadcasting platform account with information such as mobile phone number, mailbox and personal profiles before allowing the user to use the live broadcasting platform. In this way, before commission of theft, misbehaving network users have to go through these binding operations, which will increase the cost of theft. Malicious network users may forgo the theft operation due to the increased cost. As such, theft is prevented. However, the theft prevention by increasing theft cost cannot fully prevent malicious network users from stealing live broadcasting platform assets by means of invoking functional interfaces.

In the embodiment of the present application, the operations of each account logged in to the live broadcasting platform can be monitored, and each operation of a monitored account can be detected to determine whether the operation is a preset operation that can obtain an asset reward from the live broadcasting platform. If the operation is a preset operation that can obtain an asset reward from the live broadcasting platform, a determination is made as to whether the operation meets a preset normal operation rule. A failure to meet the preset normal operation rule indicates that the operation is abnormal. In this case, the asset of the account associated with the operation is frozen to protect the live broadcasting platform from asset theft. In this way, the live broadcasting platform would not suffer a loss from the theft.

In the following, the determination as to whether an operation meets the preset normal operation rule is described in detail.

In one implementation, determining whether an operation meets a preset normal operation rule may include:

determining whether there is a preset normal operation of the account previous to the operation;

if there is a preset normal operation, determining that the operation meets the preset normal operation rule;

if there is no preset normal operation, determining that the operation does not meet the preset normal operation rule.

It should be noted that the preset normal operation can be set according to specific conditions.

For example, assuming that a preset normal operation is an operation of logging in to the live broadcasting platform, and that an account B, as monitored by the server, is performing an operation of sharing a live. In case of determining that the account B shares the live without first logging in to the live broadcasting platform, such an operation of live sharing is determined to be committed by a malicious network user through invoking a live sharing functional interface, and is thus not a normal operation. As a result, the live sharing operation is determined to fail to meet the preset normal operation rule.

Conversely, in case where it is determined that the account B logs in to the live broadcasting platform before the operation of sharing a live broadcast, to ensure an accurate determination as to whether the live sharing operation meets the preset normal operation rule, in another implementation, before determining that the operation meets the preset normal operation rule, the following operations may be performed:

determining whether the order in which operations of the account are executed meets a preset execution order;

if the preset execution order is met, triggering the step of determining that the operation meets the preset normal operation rule;

if the preset execution order is met, triggering the step of determining that the operation does not meet the preset normal operation rule.

It should be noted that the preset execution order can be set according to specific conditions.

Continuing the previous example, assuming that before the operation of sharing the live, in addition to the operation of logging in to the live broadcasting platform, the account B also performs an operation of sending a gift, and these operations of the account B are executed in such an order: logging in to the live broadcasting platform->sending a gift->sharing the live. It is also assumed that the preset execution order is: entering the live studio->sharing the live. The preset execution order indicates that the operation of sharing the live shall be performed after entering the live studio. Therefore, it can be known that the order in which the operations of the account B are executed does not comply with the preset execution order. In this case, the operation, as being monitored, of sharing the live is determined to be not meet the preset normal operation rule.

In addition, in order to steal assets from the live broadcasting platform as much as possible, during the theft process, a malicious network user would frequently call the function interface for sharing a live in a short period. Therefore, in order to further prevent the theft of the assets of the live broadcasting platform. In another implementation, the following operations can also be performed:

determining whether the number of executions of the operation within a first preset period is less than or equal to a preset execution number, wherein the preset execution number is determined based on the number of executions of the operation within the first preset period for a normal operation sample;

if the number of executions is less than or equal to the preset execution number, determining that the operation meets the preset normal operation rule;

if the number of executions is greater than the preset execution number, determining that the operation does not meet the preset normal operation rule.

Continuing the previous example, assuming that for a normal operation sample, the number of executions of the live sharing operation within a minute is no more than 10, a preset execution number is 10, and the account B performs the live sharing operation for 1000 times in a minute, then it can be known that the number of executions of the live sharing operation of the account B within 1 minute is far greater than the preset execution number. As a result, it can be determined that the live sharing operation as being monitored does not meet the preset normal operation rule.

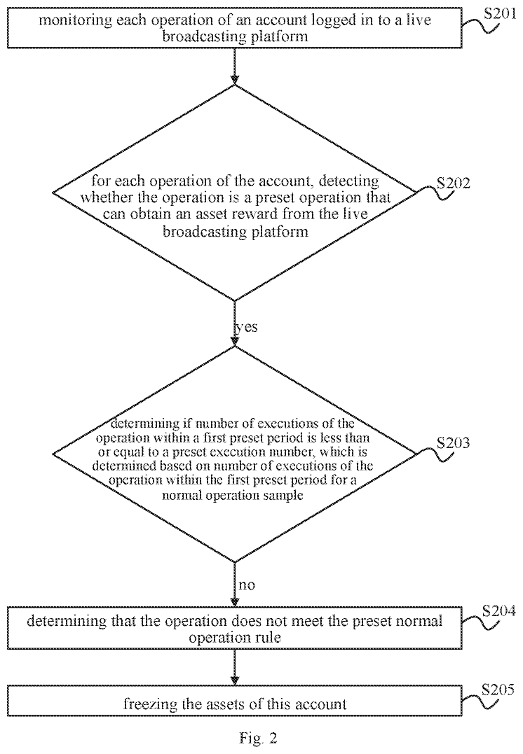

The following describes the theft prevention method corresponding to this implementation with reference to FIG. 2.

Referring to FIG. 2, the theft prevention method may include the following steps:

S201˜S202; wherein, step S201 is the same as step S101, and step S202 is the same as step S102, which will not be described in detail here.

S203: determining whether the number of executions of the operation within a first preset period is less than or equal to a preset execution number, wherein the preset execution number is determined based on the number of executions of the operation within the first preset period for a normal operation sample. If the number of executions is less than or equal to the preset execution number, performing S204; or otherwise, determining that the operation meets the preset normal operation rule.

S204: determining that the operation does not meet the preset normal operation rule; and

S205; wherein, S205 is the same as S104, details of which are not described herein.

In this implementation, a determination is made as to whether the number of executions of operation, as being monitored, within a first preset time period is less than or equal to the preset execution number. If it is greater than the preset execution number, it can be determined that the operation does not meet the preset normal operation rule, and is thus committed by a malicious network user through invoking a functional interface. In this case, the asset of the account corresponding to the operation can be frozen, so that the theft of the asset of the live broadcasting platform can be prevented.

If it is less than or equal to the preset execution number, it can be determined that the operation meets the preset normal operation rule. As a result, the freezing of the asset of the account can be skipped to ensure that users can use the asset of the account normally.

In addition, currently, in the process of theft of the assets of the live broadcasting platform, the stolen assets need to be stored in accounts of the live broadcasting platform. Therefore, in order to complete the theft of assets, malicious network users often need to register a large number of accounts. Therefore, in order to further prevent the assets of the live broadcasting platform from theft, in another implementation, the following operations can also be performed:

detecting whether the number of accounts registered with the live broadcasting platform within a second preset period exceeds a first threshold;

if the number of accounts exceeds the first threshold, determining whether the accounts registered with the live broadcasting platform within the second preset period meet a preset abnormal registration rule;

if the preset abnormal registration rule is met, freezing assets of the accounts registered with the live broadcasting platform within the second preset period.

The preset abnormal registration rule may include: the number of accounts corresponding to the same registered IP address exceeds a first preset number; the number of accounts corresponding to the same registered device exceeds a second preset number; similarity between mailbox prefixes for accounts whose number exceeds a third preset number is greater than a second threshold. Of course, embodiments are not limited in this aspect.

It can be understood that, in account registration with a live broadcasting platform, a normal user would not register an amount of accounts with the live broadcasting platform through the same IP address or the same device within a short period. Therefore, in a case where more than a first preset number of accounts registered in a second preset period correspond to the same registered IP address, these accounts corresponding to the same registered IP address can be determined as abnormal accounts. In addition, in a case where more than a second preset number of accounts registered in the second preset period correspond to the same registered device, it may be determined that these accounts corresponding to the same registered device are abnormal. At this time, the assets of these abnormal accounts can be frozen, so that the theft of assets of the live broadcasting platform can be prevented.

In addition, a normal user would not use a large number of mailbox addresses with similar mailbox prefixes (for example aaa@gmail.com, a.aa@gmail.com and aa.a@gmail.com and so on) to register with a live broadcasting platform in a short period. It is rare, even for a large number of users, to use mailbox addresses with similar mailbox prefixes to register accounts with the live broadcasting platform in a short period. Therefore, within a second preset time period which is short, more than a third preset number of accounts register with the live broadcasting platform, and the similarity between the mailboxes corresponding to the accounts exceeds a second threshold, it can be determined that these accounts exceeding the third preset number are abnormal accounts. The assets of these abnormal accounts can be frozen, so that the theft of assets of the live broadcasting platform can be prevented.

It should be noted that those skilled in the art can set the second preset time period, the first preset number, the second preset number, the third preset number, and the second threshold according to actual conditions, which will not be described in detail here. In addition, the similarity between mailbox prefixes can be calculated by a similarity algorithm, which is not described in detail here.

In summary, with the embodiments of the present application, abnormal user operations can be detected. Assets of live broadcasting platforms can be effectively protected from theft, thereby the loss of the live broadcasting platforms can be avoided.

In order to detect whether an operation is a normal operation or an abnormal operation, an embodiment of the present application provides a method for detecting operations.

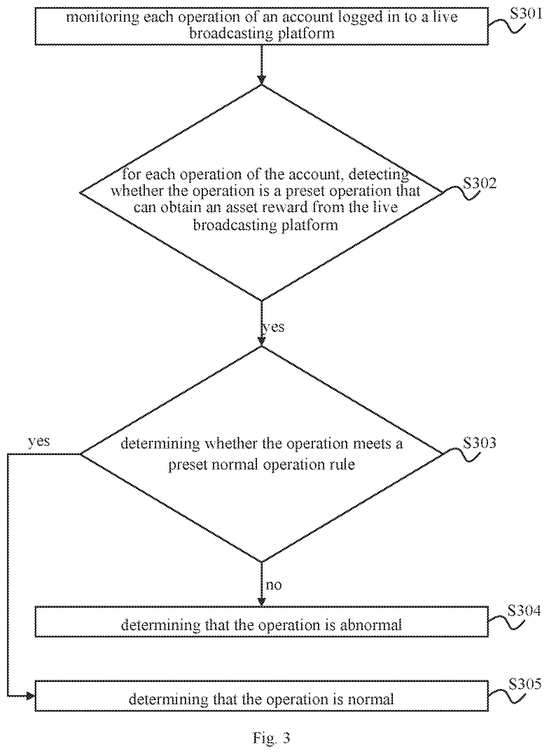

Referring to FIG. 3, the method for detecting operations provided by the embodiment of the present application may include the following steps:

S301: monitoring each operation of an account logged in to a live broadcasting platform;

S302: for each operation of the account, detecting whether the operation is a preset operation that can obtain an asset reward from the live broadcasting platform. In case of a preset operation, the method proceeds to step S303; or otherwise, step S303 is skipped.

S303: determining whether the operation meets a preset normal operation rule. If the preset normal operation rule is not met, step S304 is performed; or otherwise, step S305 is performed;

S304: determining that the operation is abnormal;

S305: determining that the operation is normal.

In the embodiment of the present application, the operations of each account logged in to the live broadcasting platform can be monitored, and each operation of each account as being monitored can be detected to determine whether the operation is a preset operation that can obtain an asset reward from the live broadcasting platform. If the operation is such a preset operation, a determination is made as to whether the operation meets a preset normal operation rule. If the preset normal operation rule is not met, the operation is determined to be abnormal. If the preset normal operation rule is met, the operation is determined to be normal. In this way, normal operations and abnormal operations can be detected.

It should be noted that after detecting that the operation is an abnormal operation, the assets of the account corresponding to the abnormal operation can be frozen. Of course, after detecting that the operation is an abnormal operation, evaluation may be made on the user of the account corresponding to the abnormal operation in aspects of payment potential and talent potential. Of course, embodiments are not limited to this.

For the description of the related content in the implementation of this application, reference can be made to the description of the corresponding content in the embodiment of the theft prevention method, which is not repeated here.

Optionally, in an embodiment of the present application, the step of determining whether the operation meets a preset normal operation rule may include:

determining whether there is a preset normal operation of the account previous to the operation;

if there is a preset normal operation, determining that the operation meets the preset normal operation rule;

if there is no preset normal operation, determining that the operation does not meet the preset normal operation rule.

Optionally, if it is determined that there is a preset normal operation of the account, before determining that the operation meets the preset normal operation rule, the method further comprises:

determining whether the order in which operations of the account are executed meets a preset execution order;

if the preset execution order is met, triggering the step of determining that the operation meets the preset normal operation rule;

if the preset execution order is met, triggering the step of determining that the operation does not meet the preset normal operation rule.

Optionally, in another embodiment of the present application, the step of determining whether the operation meets a preset normal operation rule comprises:

determining whether the number of executions of the operation within a first preset period is less than or equal to a preset execution number, wherein the preset execution number is determined based on the number of executions of the operation within the first preset period for a normal operation sample;

if the number of executions is less than or equal to the preset execution number, determining that the operation meets the preset normal operation rule;

if the number of executions is greater than the preset execution number, determining that the operation does not meet the preset normal operation rule.

In summary, with the embodiments of the present application, abnormal operations and normal operations can both be detected.

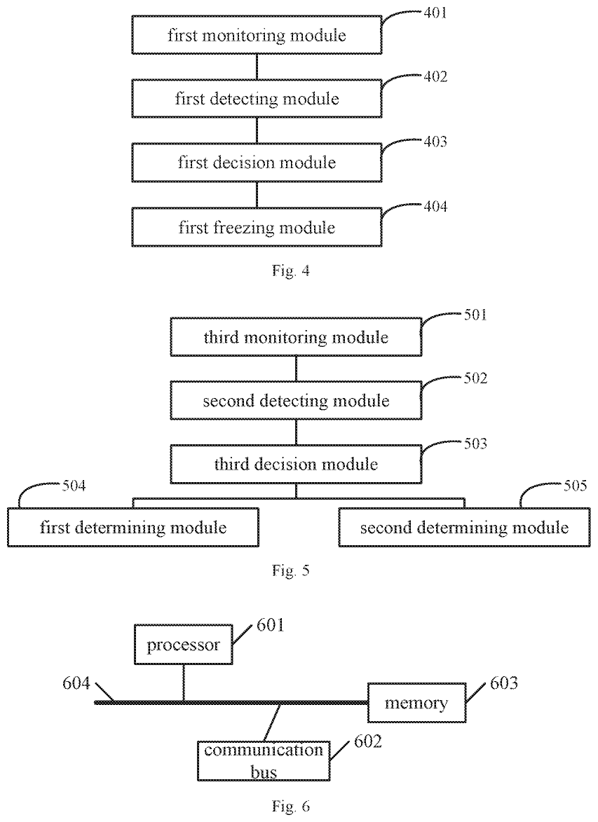

Corresponding to the foregoing embodiment of the theft prevention method, an embodiment of the present application further provides a theft prevention apparatus, which is applied to a server. Referring to FIG. 4, the apparatus may include:

a first monitoring module 401, configured for monitoring each operation of an account logged in to a live broadcasting platform;

a first detecting module 402, configured for detecting, for each operation of the account, whether the operation is a preset operation that can obtain an asset reward from the live broadcasting platform;

a first decision module 403, configured for determining whether the operation meets a preset normal operation rule if the first detecting module 402 detects that the operation is a preset operation that can obtain an asset reward from the live broadcasting platform; and

a first freezing module 404, configured for freezing an asset of the account if the first decision module 403 determines that the operation does not meet the preset normal operation rule.

In the embodiment of the present application, the operations of each account logged in to a live broadcasting platform can be monitored, and each operation of each account being monitored can be detected to determine whether the operation is the preset operation that can obtain an asset reward from the live broadcasting platform. If the operation is a preset operation that can obtain an asset reward from the live broadcasting platform, a determination is made as to whether the operation meets a preset normal operation rule. A failure to meet the preset normal operation rule indicates that the operation is abnormal. In this case, the asset of the account corresponding to the operation is frozen to ensure that the assets of the live broadcasting platform are not stolen and the loss of the live broadcasting platform is avoided.

Optionally, in an embodiment of the present application, the first decision module 403 may include:

a first decision sub-module configured for, determining whether there is a preset normal operation of the account previous to the operation if the first detecting module 402 detects that the operation is a preset operation that can obtain an asset reward from the live broadcasting platform;

a first determining sub-module configured for, determining that the operation meets the preset normal operation rule if the first decision sub-module determines that there is a preset normal operation of the account previous to the operation; and a second determining sub-module configured for, determining that the operation does not meet the preset normal operation rule if the first decision sub-module determines that there is no preset normal operation of the account previous to the operation.

Optionally, in an embodiment of the present application, the apparatus may further include:

a second decision sub-module configured for:

determining whether the order in which operations of the account are executed meets a preset execution order if the first decision sub-module determines that there is a preset normal operation of the account previous to the operation;

if the preset execution order is met, triggering the first determining sub-module to determine that the operation meets the preset normal operation rule;

if the preset execution order is not met, triggering the second determining sub-module to determine that the operation does not meet the preset normal operation rule.

Optionally, in another embodiment of the present application, the first decision module 403 may include:

a third decision sub-module configured for, determining whether the number of executions of the operation within a first preset period is less than or equal to a preset execution number if the first detecting module 402 detects that the operation is the preset operation that can obtain an asset reward from the live broadcasting platform, wherein the preset execution number is determined based on the number of executions of the operation within the first preset period for a normal operation sample;

a third determining sub-module configured for, determining that the operation meets the preset normal operation rule if the third decision sub-module determines that the number of executions of the operation within the first preset period is less than or equal to the preset execution number; and

a fourth determining sub-module configured for, determining that the operation does not meet the preset normal operation rule if the third decision sub-module determines that the number of executions of the operation within the first preset period is greater than the preset execution number.

Optionally, in an embodiment of the present application, the apparatus may further include:

a second monitoring module configured for detecting whether the number of accounts registered with the live broadcasting platform within a second preset period exceeds a first threshold;

a second decision module configured for, determining whether the accounts registered with the live broadcasting platform within the second preset period meet a preset abnormal registration rule if the second monitoring module detects that the number of accounts registered with the live broadcasting platform within the second preset period exceeds the first threshold; and

a second freezing module configured for, freezing assets of the accounts registered with the live broadcasting platform within the second preset period if the second decision module determines that the accounts registered with the live broadcasting platform within the second preset period meet the preset abnormal registration rule.

Optionally, in an embodiment of the present application, the preset abnormal registration rule may include:

the number of accounts corresponding to the same registered IP address exceeds a first preset number;

and/or, the number of accounts corresponding to the same registered device exceeds a second preset number;

and/or, similarity between mailbox prefixes for accounts whose number exceeds a third preset number is greater than a second threshold.

In summary, with the embodiments of the present application, abnormal operations can be detected. This can effectively prevent the live broadcasting platform assets from theft, thereby avoiding the loss of the live broadcasting platform.

Corresponding to the foregoing embodiment of the method for detecting operations, an embodiment of the present application further provides an apparatus for detecting operations. Referring to FIG. 5, the apparatus may include:

a third monitoring module 501 configured for monitoring each operation of an account logged in to a live broadcasting platform;

a second detecting module 502 configured for detecting, for each operation of the account, whether the operation is a preset operation that can obtain an asset reward from the live broadcasting platform;

a third decision module 503 configured for, determining whether the operation meets a preset normal operation rule if the second detecting module 502 detects that the operation is the preset operation that can obtain an asset reward from the live broadcasting platform;

a first determining module 504 configured for, determining that the operation is normal if the third decision module 503 determines that the operation meets the preset normal operation rule; and

a second determining module 505 configured for, determining that the operation is abnormal if the third decision module 503 determines that the operation does not meet the preset normal operation rule.

In the embodiment of the present application, the operations of each account logged in to the live broadcasting platform can be monitored, and each operation of each account as being monitored can be detected to determine whether the operation is a preset operation that can obtain an asset reward from the live broadcasting platform. If the operation is such a preset operation, a determination is made as to whether the operation meets a preset normal operation rule. If the preset normal operation rule is not met, the operation is determined to be abnormal. If the preset normal operation rule is met, the operation is determined to be normal. In this way, normal operations and abnormal operations can be detected.

Optionally, in an embodiment of the present application, the third decision module may include:

a fourth decision sub-module configured for, determining whether there is a preset normal operation of the account previous to the operation if the second detecting module 502 detects that the operation is a preset operation that can obtain an asset reward from the live broadcasting platform;

a fifth determining sub-module configured for, determining that the operation meets the preset normal operation rule if the fourth decision sub-module determines that there is a preset normal operation of the account previous to the operation; and

a sixth determining sub-module configured for, determining that the operation does not meet the preset normal operation rule if the fourth decision sub-module determines that there is no preset normal operation of the account previous to the operation.

Optionally, in an embodiment of the present application, the apparatus may further include:

a fifth decision sub-module configured for:

determining whether the order in which operations of the account are executed meets a preset execution order if the fourth decision sub-module determines that there is a preset normal operation of the account previous to the operation;

if the preset execution order is met, triggering the fifth determining sub-module to determine that the operation meets the preset normal operation rule;

if the preset execution order is not met, triggering the sixth determining sub-module to determine that the operation does not meet the preset normal operation rule.

Optionally, in another embodiment of the present application, the third decision module 503 may include:

a sixth decision sub-module, configured for, determining whether the number of executions of the operation within a first preset period is less than or equal to a preset execution number if the second detecting module 502 detects that the operation is the preset operation that can obtain an asset reward from the live broadcasting platform, wherein the preset execution number is determined based on the number of executions of the operation within the first preset period for a normal operation sample;

a seventh determining sub-module configured for, determining that the operation meets the preset normal operation rule if the sixth decision sub-module determines that the number of executions of the operation within the first preset period is less than or equal to the preset execution number; and

an eighth determining sub-module configured for, determining that the operation does not meet the preset normal operation rule if the sixth decision sub-module determines that the number of executions of the operation within the first preset period is greater than the preset execution number.

In summary, by applying the embodiments of the present application, abnormal operations and normal operations can be detected.

In correspondence with the foregoing embodiments of the theft prevention method, an electronic device is provided by an embodiment of the present application including, as shown in FIG. 6, a processor 601, a communication interface 602, a memory 603 and a communication bus 604, wherein the processor 601, the communication interface 602, and the memory 603 communicate with each other via the communication bus 604;

the memory 603 is used for storing a computer program;

the processor 601 is used for performing the method steps of any of the theft prevention method described above when executing the program stored on the memory 603.

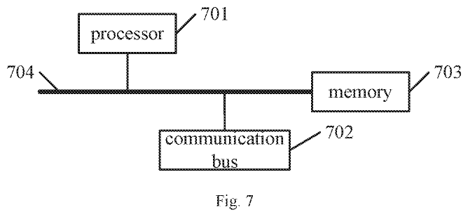

In correspondence with the foregoing embodiments of the method for detecting operations, an electronic device is provided by an embodiment of the present application including, as shown in FIG. 7, a processor 701, a communication interface 702, a memory 703 and a communication bus 704, wherein the processor 701, the communication interface 702, and the memory 703 communicate with each other via the communication bus 704;

the memory 703 is configured for storing a computer program;

the processor 701 is configured for performing steps of the method for detecting operations described above when executing the program stored on the memory 703.

The communication bus described above may be a peripheral component interconnect (PCI) bus or an extended industry standard architecture (EISA) bus, and the like. The communication bus can include an address bus, a data bus, a control bus, or the like. For representation, only one thick line is shown in the figure, which does not mean there is only one communication bus or one type of communication bus.

The communications interface is used for communication between the aforementioned electronic device and other devices.

The memory may include a random access memory (RAM), or may include non-volatile memory (NVM), for example at least one disk memory. Optionally, the memory can also be at least one storage device remote from the processor described above.

The processor described above may be a general-purpose processor, such as a central processing unit (CPU), a network processor (NP). It may also be a digital signal processor (DSP), an application specific integrated circuit (ASIC), field-programmable gate array (FPGA) or other programmable logic devices, discrete gate or transistor logic devices, discrete hardware components.

In correspondence with the embodiments of the theft prevention method as described above, embodiments of the present application provide a readable storage medium having a computer program stored thereon which, when executed by a processor, causes the processor to perform the method steps of any one of the theft prevention methods as described above.

In correspondence with the embodiments of the method for detecting operations as described above, embodiments of the present application provide a readable storage medium having a computer program stored thereon which, when executed by a processor, causes the processor to perform the method steps of any one of the methods for detecting operations as described above.

In correspondence with the embodiments of the theft prevention method as described above, embodiments of the present application further provide a computer program product containing instructions which, when executed on a computer, cause the computer to perform the method steps of any one of the theft prevention methods as described above.

In correspondence with the embodiments of the method for detecting operations as described above, embodiments of the present application further provides a computer program product containing instructions which, when executed on a computer, cause the computer to execute the method steps of any one of the methods for detecting operations as described above.

It should be noted that the relationship terms herein such as “first”, “second” and the like are only used for distinguishing one entity or operation from another entity or operation, but do not necessarily require or imply that there is any actual relationship or order between these entities or operations. Moreover, the terms “include”, “comprise” or any other variants thereof are intended to cover non-exclusive inclusions, so that processes, methods, articles or devices comprising a series of elements comprise not only those elements listed but also those not specifically listed or the elements intrinsic to these processes, methods, articles, or devices. Without further limitations, elements defined by the sentences “comprise(s) a.” or “include(s) a.” do not exclude that there are other identical elements in the processes, methods, articles, or devices which include these elements.

All the embodiments are described in corresponding ways, same or similar parts in each of the embodiments can be referred to one another, and the parts emphasized are differences to other embodiments. Especially for embodiments of a system, since they are similar to embodiments of a method, the description thereof is relatively simple; the similar parts could refer to the parts in the description of embodiments of the method.

The embodiments described above are merely preferred embodiments of the present application, and not intended to limit the scope of the present application. Any modifications, equivalents, improvements or the like within the spirit and principle of the application should be included in the scope of the application.

1. A theft prevention method, comprising:
monitoring each operation of an account logged into a live broadcasting platform;
for each operation of the account, detecting whether the operation is a preset operation that can obtain an asset reward from the live broadcasting platform;
if the operation is the preset operation, determining whether the operation meets a preset normal operation rule; and
if the operation does not meet the preset normal operation rule, freezing an asset of the account.

2. The method according to claim 1, wherein, determining whether the operation meets a preset normal operation rule comprises:
determining whether there is a preset normal operation of the account previous to the operation;
if there is a preset normal operation, determining that the operation meets the preset normal operation rule;
if there is no preset normal operation, determining that the operation does not meet the preset normal operation rule.

3. The method according to claim 2, wherein, if determining that there is a preset normal operation of the account, before determining that the operation meets the preset normal operation rule, the method further comprises:
determining whether the order in which operations of the account are executed meets a preset execution order;
if the preset execution order is met, triggering the step of determining that the operation meets the preset normal operation rule;
if the preset execution order is met, triggering the step of determining that the operation does not meet the preset normal operation rule.

4. The method according to claim 1, wherein, determining whether the operation meets a preset normal operation rule comprises:
determining whether the number of executions of the operation within a first preset period is less than or equal to a preset execution number, wherein the preset execution number is determined based on the number of executions of the operation within the first preset period for a normal operation sample;
if the number of executions is less than or equal to the preset execution number, determining that the operation meets the preset normal operation rule;
if the number of executions is greater than the preset execution number, determining that the operation does not meet the preset normal operation rule.

5. The method of claim 1, further comprising:
detecting whether the number of accounts registered with the live broadcasting platform within a second preset period exceeds a first threshold;
if the number of accounts exceeds the first threshold, determining whether the accounts registered with the live broadcasting platform within the second preset period meet a preset abnormal registration rule;
if the preset abnormal registration rule is met, freezing assets of the accounts registered with the live broadcasting platform within the second preset period.

6. The method of claim 5, wherein, the preset abnormal registration rule comprises:
the number of accounts corresponding to the same registered IP address exceeds a first preset number;
and/or, the number of accounts corresponding to the same registered device exceeds a second preset number;
and/or, similarity between mailbox prefixes for accounts whose number exceeds a third preset number is greater than a second threshold.

7. (canceled)

8. A theft prevention apparatus, comprising:
a first monitoring module configured for monitoring each operation of an account logged in to a live broadcasting platform;
a first detecting module configured for detecting, for each operation of the account, whether the operation is a preset operation that can obtain an asset reward from the live broadcasting platform;
a first decision module configured for, determining whether the operation meets a preset normal operation rule if the first detecting module detects that the operation is a preset operation that can obtain an asset reward from the live broadcasting platform; and
a first freezing module configured for, freezing an asset of the account if the first decision module determines that the operation does not meet the preset normal operation rule.

9. The apparatus according to claim 8, wherein the first decision module comprises:
a first decision sub-module configured for, determining whether there is a preset normal operation of the account previous to the operation if the first detecting module detects that the operation is a preset operation that can obtain an asset reward from the live broadcasting platform;
a first determining sub-module configured for, determining that the operation meets the preset normal operation rule if the first decision sub-module determines that there is a preset normal operation of the account previous to the operation; and
a second determining sub-module configured for, determining that the operation does not meet the preset normal operation rule if the first decision sub-module determines that there is no preset normal operation of the account previous to the operation.

10. The apparatus according to claim 9, further comprising:
a second decision sub-module configured for:
determining whether the order in which operations of the account are executed meets a preset execution order if the first decision sub-module determines that there is a preset normal operation of the account previous to the operation;
if the preset execution order is met, triggering the first determining sub-module to determine that the operation meets the preset normal operation rule;
if the preset execution order is not met, triggering the second determining sub-module to determine that the operation does not meet the preset normal operation rule.

11. The apparatus according to claim 8, wherein the first decision module comprises:
a third decision sub-module configured for, determining whether the number of executions of the operation within a first preset period is less than or equal to a preset execution number if the first detecting module detects that the operation is the preset operation that can obtain an asset reward from the live broadcasting platform, wherein the preset execution number is determined based on the number of executions of the operation within the first preset period for a normal operation sample;
a third determining sub-module configured for, determining that the operation meets the preset normal operation rule if the third decision sub-module determines that the number of executions of the operation within the first preset period is less than or equal to the preset execution number; and
a fourth determining sub-module configured for, determining that the operation does not meet the preset normal operation rule if the third decision sub-module determines that the number of executions of the operation within the first preset period is greater than the preset execution number.

12. The apparatus according to claim 8, further comprising:
a second monitoring module configured for detecting whether the number of accounts registered with the live broadcasting platform within a second preset period exceeds a first threshold;
a second decision module configured for, determining whether the accounts registered with the live broadcasting platform within the second preset period meet a preset abnormal registration rule if the second monitoring module detects that the number of accounts registered with the live broadcasting platform within the second preset period exceeds the first threshold; and
a second freezing module configured for, freezing assets of the accounts registered with the live broadcasting platform within the second preset period if the second decision module determines that the accounts registered with the live broadcasting platform within the second preset period meet the preset abnormal registration rule.

13. The apparatus according to claim 12, wherein, the preset abnormal registration rule comprises:
the number of accounts corresponding to the same registered IP address exceeds a first preset number;
and/or, the number of accounts corresponding to the same registered device exceeds a second preset number;
and/or, similarity between mailbox prefixes for accounts whose number exceeds a third preset number is greater than a second threshold.

14. (canceled)

15. An electronic device, comprising a processor, a communication interface, a memory, and a communication bus, wherein the processor, the communication interface, and the memory communicate with each other through the communication bus;
the memory is configured for storing a computer program;
the processor is configured for performing the method steps of claim 1 when executing the program stored on the memory.

16. (canceled)

17. A non-transitory computer readable storage medium having a computer program stored thereon which, when executed by a processor, causes the processor to perform the method steps of claim 1.

18-20. (canceled)
